(19) United States
(12) Patent Application Publication
(10) Pub. No.: US 2005/0246687 A1
(43) Pub. Date: Nov. 3, 2005

(54) Determination of the status of an object in a source control system and a method to automatically check-in an object when its definition is provided from an external source

(76) Inventor: Jeffrey B. Scott, Lexington, VA (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/729,773

(22) Filed: May 3, 2004

(51) Int. Cl. G06F 9/44

(52) U.S. Cl. 717/122

(57) ABSTRACT

When a user makes a request to modify a definition of an object under control of a source control system via an external source (i.e., an import), a check is done to make sure that the object is currently checked-in. If not, then the import is not allowed. If it is checked-in, then the new definition is automatically checked-in.

### BACKGROUND OF THE INVENTION

1. Field of the Invention

The present disclosure generally relates to source control systems for objects. In particular, the present disclosure relates to version control, importing, automatic check-in, process automation, and other applications and features.

2. Discussion of the Background Art

Source control is also known as configuration management or change management. Source control is the discipline of making changes to source code in a planned and systematic fashion. The purpose of source control is to formally control the integrity of artifacts (items) and activities (tasks). Source control has four primary activities: identification, management, status accounting, and auditing.

Identification is the task of identifying (documenting/baselining) artifacts, i.e. the items that make up systems. Some artifacts include software, hardware, and firmware.

Management is the introduction of controls (procedures and quality gates) to ensure products or systems evolve appropriately. Some example areas of focus include deployment and release practices, issue tracking practices, change request practices, asset management practices, and system management practices.

Status accounting is capturing configuration management data, processing data, and using the information. The objective is to provide information to support management and decision making. Some example groups and individuals that benefit from this information are configuration management, security, quality assurance, project managers, and engineers.

Auditing is reviewing the status accounting against the defined or required standards. Some areas of focus include adherence to process, conformance to security, and configuration verification.

The items under control in a source control system include objects, such as control strategies. In object-oriented programming (OOP), objects are abstractions used in designing a program and they are also the units of code that are eventually derived from the design process. In between, each object is made into a generic class of object and even more generic classes are defined so that objects can share models and reuse the class definitions in their code. Each object is an instance of a particular class or subclass with the class' own methods or procedures and data variables. Thus, objects typically exist in a hierarchy of objects with parent and child relationships. An object is usually a binary, text, or other type of file.

In a source control system, objects are checked-out, edited, and then checked-in. Each time an object is checked-in, it is given a version number. Over time, a history of changes is created for the objects under the control of the source control system.

Some customers who manage process control systems have a central site where they develop a process control strategy to distribute to local sites within their company. These customers want to make sure that there is a record of the exact strategy that was distributed. There is a need for an automatic check-in during an import (i.e., loading the strategy into a database) from an external source that automatically knows that the strategy needs to be under source control, creates a record of the strategy, and does not allow any changes until the strategy is put into the database. So, after an import, there would be no need to do a manual check-in, as required by conventional source control systems. Any changes would be under source control. As a result, there would be a history of the strategy so that, if necessary, it would be possible to get back to the first version of the strategy, creating an accurate history and enhancing central control over local use of the strategy.

In a process automation system that has changes controlled by a source control system, a user may want to update a definition of an object from an external source. The user wants to ensure that this new definition cannot be modified without a record of the change. Normally, source control guidelines require the object to be checked-out in order to change the definition. However, this does not safeguard the new definition from being modified before it is saved and checked-back-in. There is a need for a source control system that does not allow changes to an externally provided object definition, because the system automatically checks-in the new definition.

### SUMMARY OF THE INVENTION

The present invention has various aspects and is directed to determination of the status of an object in a source control system and a method to automatically check-in an object when its definition is provided from an external source that satisfy these and other needs.

One aspect is a source control system for a process control system including a processor, an import function, a validation function, and a check-in function. The processor is in a process control system. The import function operates on the processor to import an object from an external source. The validation function operates on the processor to determine whether the object is eligible for automatic check-in. The check-in function operates on the processor and is performed automatically upon import, including determining a version number for the object. In some embodiments, the object defines a control strategy. In some embodiments, the source control system also includes at least one controller capable of being loaded with the control strategy by the processor. In some embodiments, the source control system also includes at least one client in communication with the processor. In some embodiments, the control strategy is distributed from the processor to the clients. In some embodiments, the source control system also includes a database accessible by the processor to store the object.

Another aspect is a method of automatic check-in for a source control system in a process control system. An import request for an import object is received from an external source from a user. In some embodiments, the import object defines a control strategy. The import request is validated and automatically checked-in. An import status is provided.

In some embodiments, validation has several parts. It is determined if the import object already exists as an existing object in a source control system. It is determined if the existing object has a status of checked-in. It is determined if the user has permission to check-in. The status of the existing object is locked. Later, the status is unlocked.

In some embodiments, automatically checking-in the import object has several parts. It is determined if the import object already exists as an existing object in a source control system. It is determined if the status of the existing object is locked. A new version number for a new version of the existing object is determined. The import object is checked-in as the new version using the new version number. A comment is stored in the source control system indicating an automatic check-in for the new version.

In some embodiments, determining the new version number for the new version has several parts. The existing version number of the existing object is determined. An import version number from the import object is determined. The new version number is set to a minor increment of the existing version number, if the import version number is equal to the existing version number. The new version number is set to a major increment of the existing version number, if the import version number is less than the existing version number. The new version number is set to the import version number, if the import version number is greater than the existing version number.

### BRIEF DESCRIPTION OF THE DRAWINGS

These and other features, aspects, and advantages of the present disclosure will become better understood with reference to the following description, appended claims, and drawings where:

FIGS. 1A-1F form a flow chart of an example method for automatic check-in;

FIG. 2 is a screenshot of an example user interface for an import function;

FIG. 3 is a screenshot of an example version history for an object before it has been automatically checked-in;

FIG. 4 is a screenshot of the example version history for the object of FIG. 3 after it has been automatically checked-in; and

FIG. 5 is a block diagram of an example system architecture capable of performing a method for automatic check-in.

### DETAILED DESCRIPTION OF THE PREFERRED EMBODIMENT

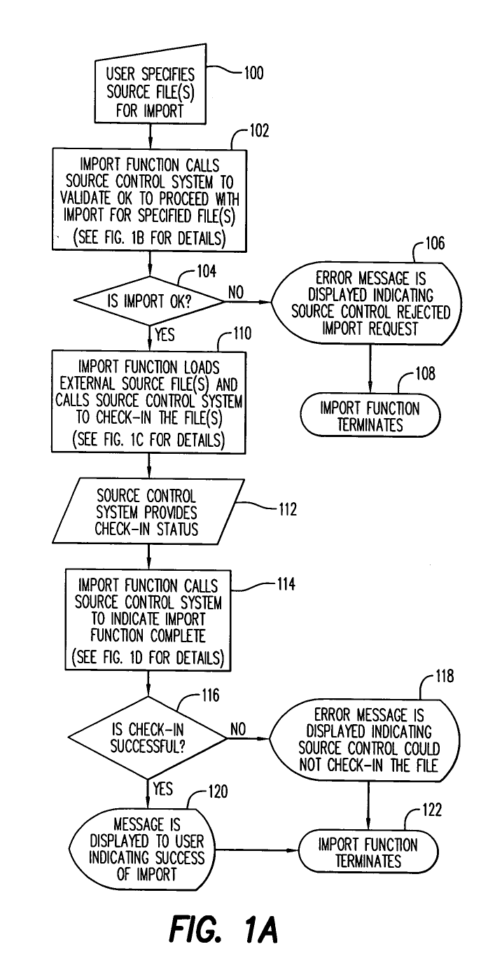

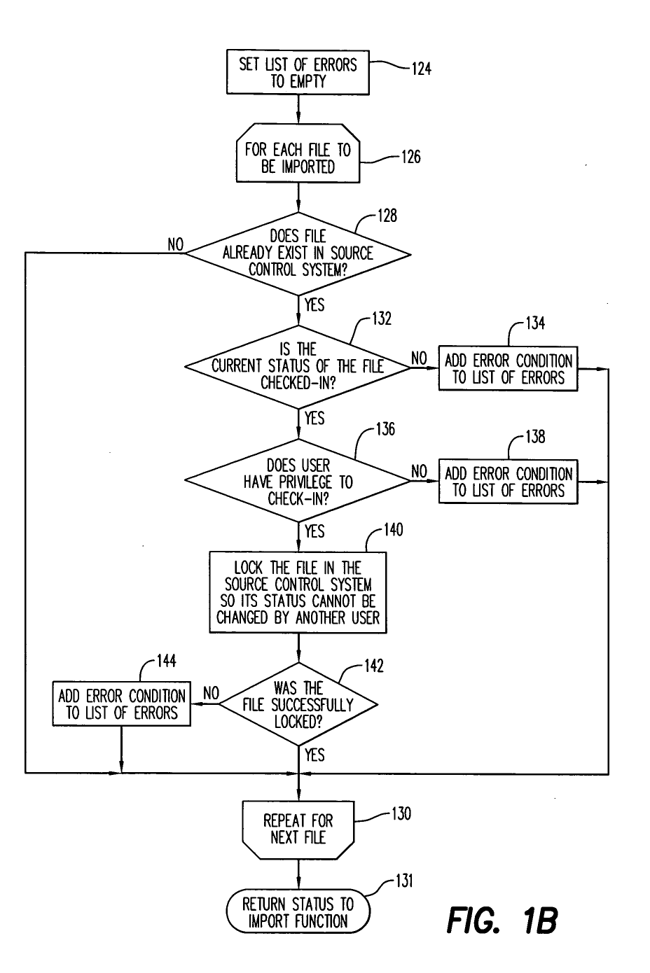

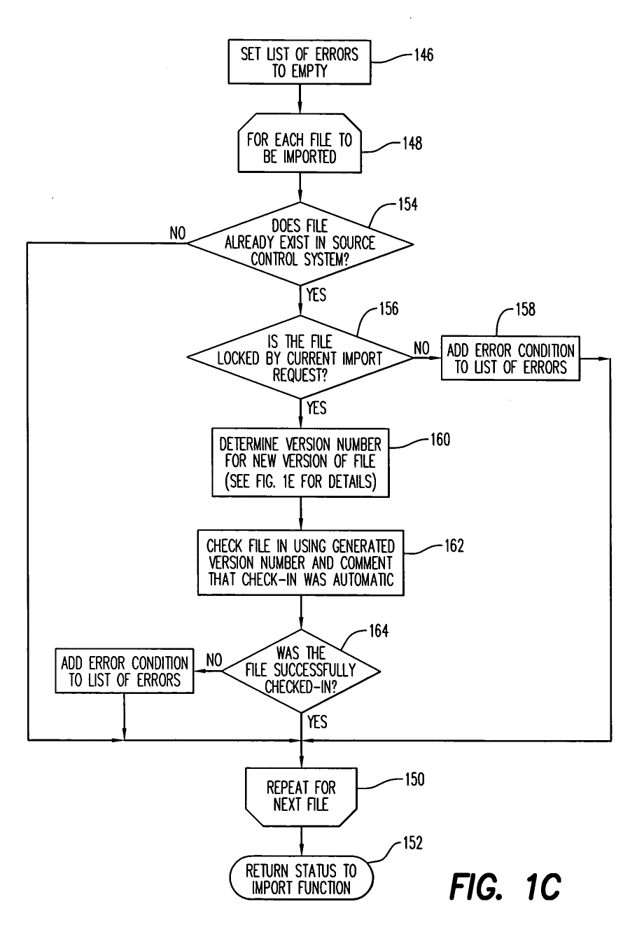

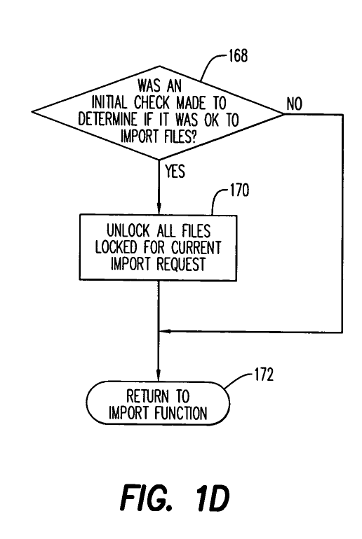

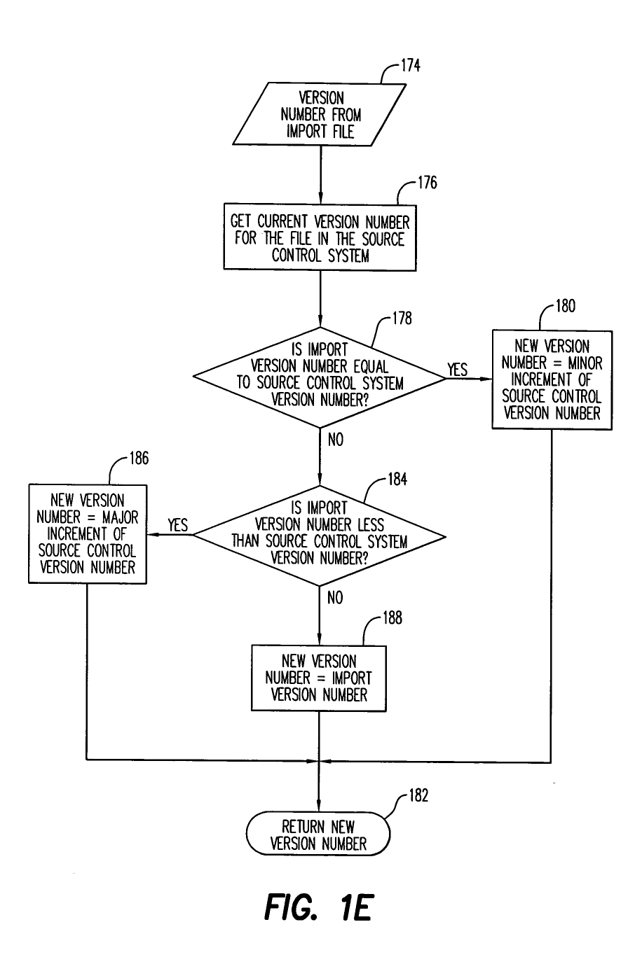

FIGS. 1A-1F show a flow chart of an example method for automatic check-in. In step 100, a user specifies one or more source files to be imported. To import is to load the definition of a control strategy to a database, so that it is available for loading to a controller. A controller is a machine, typically a computer, that controls a process. Generally, importing is converting the external source file of the object to an internal representation in the source control system. A control strategy is a combination of control elements to control a particular action in a process control system. In step 102, the import function calls a source control system to validate that it is okay to proceed with the import for the specified files. FIG. 1B shows the validation process in detail. In FIGS. 1A-1F, optional error processing is shown and errors may be handled in different ways in various embodiments of the present invention.

In step 104, if the import is not valid, then control flows to step 106 where an error message is displayed indicating that the source system rejected the import request and then control flows to step 108 where the import function terminates. In step 104, if the import is valid, control flows to step 110 where the import function loads the external source files and calls the source control system to check-in the files. An external source file is a file that defines an object and that is outside of the source control system and not under its control. An external file may have been created by an export function of the source control system. Exporting is making a copy of the object in the source control system for use outside the control of the source control system. FIG. 1C shows the check-in process in detail. In step 112, the source control system provides a check-in status. In step 114, the import function calls the source control system to indicate that the import function is complete. FIG. 1D shows the processing performed by the source control system when called by the import function to terminate import processing.

In step 116, if check-in is not successful, then control flows to step 118 where an error message is displayed indicating that the source control system could not check-in the file. In step 116, if check-in is successful, then control flows to step 120 where a message is displayed to the user indicating a successful import. Whether or not the check-in was successful, the import function terminates at step 122.

FIG. 1B shows the validation process in detail. In step 124, a list of errors is set to empty. In step 126, for each file to be imported, a loop is performed. The file contains a definition of the object and may be in any format, such as extensible markup language (XML) or other representation capable of providing the information. In this description, file is used interchangeably with object. In step 128, if the file does not already exist in the source control system, then control flows to step 130 and the loop is repeated for the next file until there are no more files. When there are no more files, the loop is exited and control flows to step 131 where to return the validation status to the import function in FIG. 1A. In step 128, if the file already exists in the source control system, then control flows to step 132. In step 132, if the current status of the file is not checked-in, then control flows to step 134. In step 134, an error condition is added to the list of errors and control flows to step 130. In step 132, if the current status of the file is checked-in then control flows to step 136. In step 136, if the user does not have the privilege to check-in, an error condition is added to the list of errors in step 138 and control flows to step 130. Otherwise, if in step 136, the user does have the privilege to check-in, then control flows to step 140. In step 140, the file is locked in the source control system so that its status cannot be changed by another user. Then, in step 142, if the file was not successfully locked, an error condition is added to the list of errors in step 144 and control flows to step 130. If, in step 142, the file was successfully locked, then control flows to step 130. Once all the files to be imported are processed in the loop, control flows to step 131, and the validation status is returned to the import function for use in step 104 in FIG 1A.

FIG. 1C shows the check-in process in detail. In step 146, the list of errors is set to empty. In step 148, for each file to be imported a loop is performed until it is exited at step 150 and, in step 152, a check-in status is returned to the import function for use in step 112 in FIG. 1A. At the top of the loop in step 154, if the file does not already exist in the source control system then control flows to step 150. Otherwise, if the file already exists in the source control system then control flows to step 156. In step 156, if the file is not locked by the current import request, then an error condition is added to the list of errors in step 158 and control flows to step 150. Otherwise, if the file is locked by the current import request then control flows to step 160. In step 160, a version number is determined for a new version of the file. Version numbers generally are unique numbers associated with objects in a source control system. Usually, version numbers strictly increase, do not decrease, and are not re-used. FIG. 1E shows the determination of the version number for the new file in detail. In step 162, the file is checked-in using the generated version number and a comment is stored indicating that the check-in was performed automatically. In step 164, if the file was not checked-in successfully, an error condition is added to the list of errors in step 166 and control flows to step 150. Otherwise, if the file was checked-in successfully, control flows to step 150. Upon exiting the loop, in step 152, the check-in status is returned to the import function for use in step 112 in FIG. 1A

FIG. 1D shows the processing performed by the source control system when called by the import function to terminate import processing. In step 168, if an initial check was not made to determine if it was okay to import the files then, in step 170, control is returned to the import function in FIG. 1A. Otherwise, if the initial check was made to determine if it was okay to import the files, then control flows to step 170. In step 170, the system unlocks all the files that were locked for the current import request. In step 172, control returns to the import function in FIG. 1A.

FIG. 1E shows the determination of the version number for the new file in detail. In step 174, the version number from the import file is determined. In step 176, the current version number for the file in the source control system is determined. In step 178, if the import version number is equal to the source control system version number, then control flows to step 180. Otherwise, if the import version number is not equal to the source control system version number, then control flows to step 184. In step 180, the new version number is set equal to a minor increment of the source control version number and returned in step 182 to be used in step 160 in FIG. 1C. An example of a minor increment is going from “1.00” to “1.01”, while a major increment is going from “1.00” to “2.00”. In step 184, if the import version number is less than the source control version number then control flows to step 186. In step 186, the new version number is set equal to a major increment of the source control version number and control flows to step 182. Otherwise, in step 184, if the import version number if greater than the source control version number, then control flows to step 188. In step 188, the new version number is set equal to the import version number and control flows to step 182. In step 182, the new version number is returned to be used in step 160 in FIG. 1C.

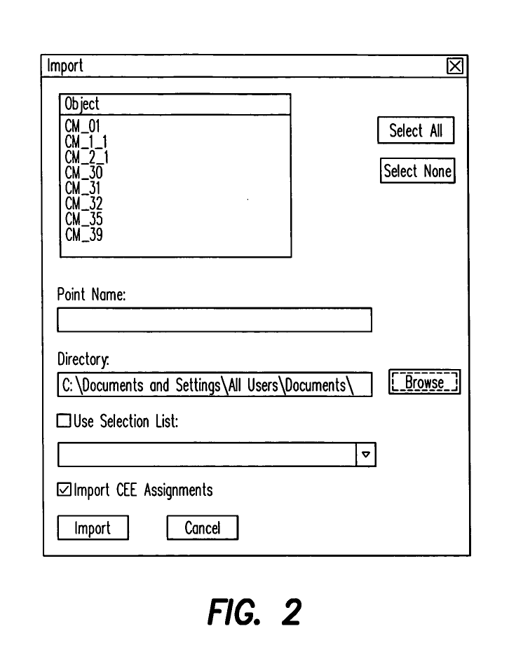

FIG. 2 shows an example user interface for an import function. In this example, CM_01 is selected using one of the various methods shown to be imported. CM_01 is a file containing the object definition. During import, the object defined in file CM_01 will be automatically checked-in.

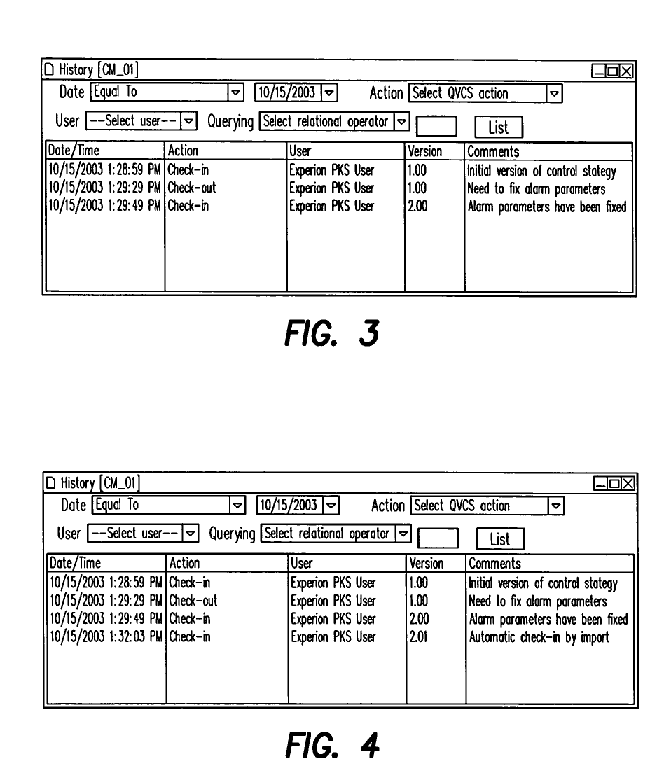

FIG. 3 shows an example version history for an object before it has been automatically checked-in. In this example, version 2.00 of the object CM_01 was last checked-in on Oct. 15, 2003 at 1:29:49 p.m. by “Experion PKS User” with the comment “Alarm parameters have been fixed.” The object CM_01 has not yet been automatically checked-in.

FIG. 4 shows the example version history for the object of FIG. 3 after it has been automatically checked-in. In this example, version 2.01 of the object CM_01 was automatically checked-in on Oct. 15, 2003 at 1:32:03 p.m. by “Experion PKS User” with the comment “Automatic check-in by import.”

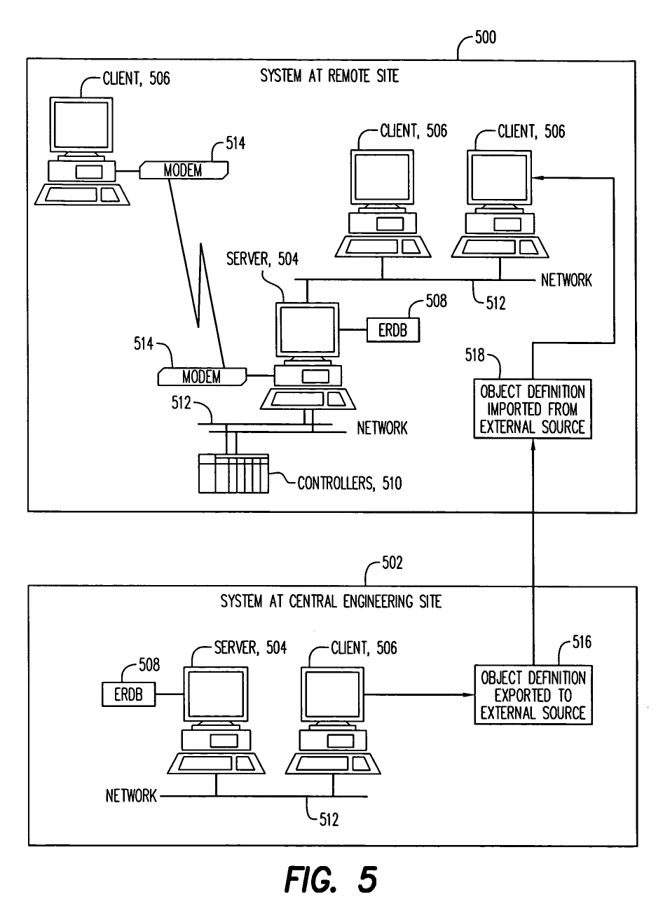

FIG. 5 shows an example system architecture capable of performing a method for automatic check-in. There is a system at a remote site 500 and a system at a central engineering site 502. Both systems have servers 504 and clients 506. Each server 504 has access to a database 508, which in this example is the Engineering Repository Database (ERDB). The ERDB holds definitions of templates and strategies, among other information. At the remote site 500, server 504 is in communication with controllers 510. In this example, various networks 512 and modems 514 provide communication. Systems for performing a method for automatic check-in may have various configurations.

An object definition is exported at central engineering site 502 and stored on an external source 516, such as a floppy disk, CD, or a storage device. When the object definition is imported 518 into the source control system at remote site 500, by client 506, it is automatically checked-in. In one example the object definition is a control strategy. Client 506 imports the control strategy into the source control system at remote site 500 and then uses it to operate controllers 510 in a process control system. The automatic check-in during import may be used in the Qualification and Version Control System (QVCS™) for the Experion Process Knowledge System (Experion PKS™) from Honeywell International. However, the present invention is applicable to many other source control systems and other system architectures.

In an example embodiment, the type of object placed in a source control system is a control strategy. A control strategy has one or more control components, such as an AND block, digital input block, and the like. These blocks are put in place by the user and contain parameters configured by the user to perform the desired control actions. The import function is used for creation or re-creation of objects and the source control system distinguishes between these actions so that the appropriate versioning functions are invoked. Extensible markup language (XML) files are created by the export function that do not contain information about whether or not the files were under source control, i.e., checked-in or checked-out. These XML files contain version data, such as version number, version date, creator, and the like that may or may not be appropriate to import, depending on the context, i.e., importing that results in automatic check-in or object creation without automatic check-in. In addition, interaction with the source control system may be required to properly handle the import request.

In this example, an object is importable from a source control system to a non-source control system and vice-versa. A user may import an object only if it is not under control of the source control system or if it is checked-in to the source control system. An object not under control means that the object has never been checked-in to the source control system. If the object is under control of the source control system, the object is checked-into the source control system as part of the import. An object that is in the source control system and has been deleted is not importable.

The version information that is displayed for an object that is not under control of the source control system after an import has been performed is the version information that is in an import file. This information is updated as necessary when the object is checked-in. If the version number of an object that is imported is kept the same, then it is possible to verify that objects that are used on multiple site are identical.

In this example, there is a method to prevent an export file from being modified. An example use is for distribution of centrally managed control strategies with the ability to lock out changes by sites receiving those strategies.

In this example, whether an import is allowed is based on the status or existence of the object being imported. Some example rules for importing objects are summarized in Table 1.

TABLE 1
Import Rules

| | | | Existing | |
|---|---|---|---|---|
| Import | | | object not in | |
| version | | | source | Object |
| number | Existing object | Existing object | control | does not |
| status | checked-in | checked-out | system | exist |
| Version no. | Import OK, | Import not | Import OK, | N/A |
| <> tree object | replaces existing. | allowed. | replaces | |
| version no. | Automatically | | existing. | |
| Version no. = | checked-in and | | Version | |
| tree object | version number | | number is | |
| version no. | adjusted as needed | | set from | |
| | (see Table 2). | | import | |
| No object in | Error. If object in | Error. If object | N/A | Import OK. |
| tree | source control | in source | | Version |
| | system, must also | control system, | | number is |
| | be in tree | must also be in | | set from |
| | | tree | | import |

In this example, an object is only imported if the object in the destination database is also checked-in, if the object is not under version control or if the object does not exist. In addition, the resultant imported object is automatically checked-in if the existing object is under control of the source control system. If the object does not exist in the source control system, the version number that is assigned is based on the version number in the import file. For an object that is automatically checked-in, the rules for determining the exact version number that will be assigned in this example are shown in Table 2.

TABLE 2
Determination of Version Number

| Import Version Number | Resultant Version Number on check-in |
|---|---|
| Version number < | Version number is set to |
| highest version number | major increment of highest |
| | version number |
| Version number = | Version number is set to |
| highest version number | minor increment of highest |
| | version number |
| Version number > tree | Version number is set to |
| object version number | the imported version number |
| Object not under | |
| version control or does | |
| not exist | |

In this example, there is a method to perform validation and to ensure that it is okay to import a specified object. This method is performed prior to importing an object. A method is also performed to validate that a user export is allowed, i.e., the object is not currently being processed by the source control system.

It is to be understood that the above description is intended to be illustrative and not restrictive. Many other embodiments will be apparent to those of skill in the art upon reviewing the above description, such as adaptations of the present disclosure to source control for applications other than process control systems. Various designs using hardware, software, and firmware are contemplated by the present disclosure, even though some minor elements would need to change to better support the environments common to such systems and methods. The present disclosure has applicability to fields outside process control, such as software development environments and other kinds of systems needing source control. Therefore, the scope of the present disclosure should be determined with reference to the appended claims, along with the full scope of equivalents to which such claims are entitled.

1. A source control system for a process control system, comprising:
a processor in a process control system;
an import function operable on said processor to import an object from an external source;
a validation function operable on said processor to determine whether said object is eligible for automatic check-in; and
a check-in function operable on said processor to be performed automatically upon import, including determining a version number for said object.

2. The system according to claim 1, wherein said object defines a control strategy.

3. The system according to claim 2, further comprising at least one controller capable of being loaded with said control strategy by said processor.

4. The system according to claim 3, further comprising at least one client in communication with said processor.

5. The system according to claim 4, wherein said control strategy is distributed from said processor to said at least one client.

6. The system according to claim 1, further comprising a database accessible by said processor to store said object.

7. A method of automatic check-in for a source control system in a process control system, comprising:
receiving an import request for an import object from an external source from a user;
validating said import request;
automatically checking-in said import object; and
providing an import status.

8. The method according to claim 7, wherein said validating said import request comprises:
determining if said import object already exists as an existing object in a source control system;
determining if said existing object has a status of checked-in;
determining if said user has permission to check-in; and
locking said status of said existing object.

9. The method according to claim 8, further comprising:
unlocking said status of said existing object, after said import object has been automatically checked-in.

10. The method according to claim 7, wherein said automatically checking-in said import object comprises:
determining if said import object already exists as an existing object in a source control system;
determining if a status of said existing object is locked;
determining a new version number for a new version of said existing object;
checking-in said import object as said new version using said new version number; and
storing a comment in said source control system indicating an automatic check-in for said new version.

11. The method according to claim 7, wherein determining said new version number for said new version comprises:
determining an existing version number of said existing object;
determining an import version number from said import object;
setting said new version number to a minor increment of said existing version number, if said import version number is equal to said existing version number;
setting said new version number to a major increment of said existing version number, if said import version number is less than said existing version number; and
setting said new version number to said import version number, if said import version number is greater than said existing version number.

12. The method according to claim 7, wherein said import object defines a control strategy.
